(19) United States
(12) Patent Application Publication
(10) Pub. No.: US 2002/0061218 A1
(43) Pub. Date: May 23, 2002

(54) Keyboard for engineering uses

(76) Inventor: Hwang Zong Hsii, Taipei (TW)

Correspondence Address: Harold L. Novick, 6th Fl, 1030 Fifteenth Street, N.W., Washington, DC, 20005, US

(21) Appl. No.: 09/988,409

(22) Filed: Nov. 19, 2001

(30) Foreign Application Priority Data
Nov. 18, 2000 (TW) 089220038

(51) Int. Cl. B41J 5/16

(52) U.S. Cl. 400/489

(57) ABSTRACT

A keyboard, for example, for engineering purposes derived from a tradition typewriter where alphanumeric keyboards for use in potable computer, control units etc., and more particularly to alphanumeric keyboards for switching the number key from the right side to the left side on the keyboard. The characteristics of the keyboard includes a numeric key pad located on the left side of the keyboard so that it can either be set for left hand touch pad control, or for depression of conventional keys on a keyboard and simultaneously set for right hand control of a mouse, including moving the mouse and clicking on one of the mouse buttons. During the time a user is working on the keyboard, it is particularly adapted to the specific use of the keypad numerical portion of the keyboard by the left hand and a mouse by the right hand and is especially useful for use by an engineer.

### BACKGROUND OF THE INVENTION

1. Technical Field of the Invention

The present invention relates to keyboards for conventional computers, including desktop and portable microcomputers, minicomputers, and main frame computers. More particularly, the present invention relates to alphanumeric keyboards for specialty uses such as for engineering purposes.

2. Description of Related Art

There have been numerous attempts to devise means for entering alphanumeric characters into a computer system while simultaneously permitting a second entry into the computer. For example, it is desirable in many professions, such as engineering, to allow simultaneous alphanumeric entry of data from a conventional keyboard and an entry from a mouse. This permits a keyboard and a mouse to be used at the same time for fast and reliable operation. None of these known prior art attempts, however, have been entirely successful.

A lot of patents disclose a keyboard for one-handed operation, such as the “Mathias keyboard” which comprises a keyboard derived from the Sholes keyboard. In these keyboards, a so-called “modifier key” is used. Although it is possible for a person who is accustomed to using a keyboard to learn touch typing relatively quickly on the Mathias keyboard, the necessary application of the modifier key constitutes an unnatural element in the writing process and is felt by some users to be cumbersome. Otherwise, a lot of keyboard improvements have been offered, but still these approaches not such a better than present application.

There is also a different utilized in so-called chorded keyboards, in which simultaneous depression of a specific combination of keys corresponds to a specific alphanumeric character. The technique utilized in aforesaid chorded keyboard thus constitutes a major departure from the conventional “Qwerty” writing process utilized in the Sholes keyboard and hence requires a considerable learning period, a fact which makes the chorded keyboard and the aforesaid key board less acceptable from the users'point of view.

A UK patent 2 122787 discloses a one hand keyboard which can either be adapted to right-hand or left-hand use. That keyboard according to that invention utilizes a full character keyboard, although the characters' position on the keyboard differs from the positions on the normal Sholes keyboard. The UK keyboard comprises two modes of operation: a first mode in which the characters are written as indicated on the keyboard and a second mode, in which the character being written is mirrored in a plane subdividing the keyboard into two equal parts. Hardware or software means are used in order to shift between these two modes of operation with the aim of providing either a right-hand version or a left-hand version of the keyboard.

All of the above mentioned systems suffer from considerable drawbacks both regarding the mechanical writing process and regarding the sized of the keys in the case of a keyboard with one key for each character. These drawbacks may result in less acceptance of the keyboard due to an “unnatural” writing process and an inevitable learning period and in reduced writing speed and/or increase number of errors.

### SUMMARY OF THE INVENTION

In view of the foregoing and other known drawbacks and disadvantages of the prior art, it is thus desirable to devise a keyboard for left-hand touch or depress typing which is reliable, readily usable for people accustomed to any normal keyboard and which enable drawing speeds compare with any keyboard in market.

Furthermore, in many professions, such as engineering, in which a numeric keypad is very frequently used, the keyboard user has to switch his or her right hand between keyboard use and mouse use, and this is a problem. This problem is solved according to the invention with a keyboard, which is basically derived from the normal Sholes keyboard by re-locating the numeric characters in the numeric pad on the keyboard. The numeric characters include the following series of ten character, 1, 2, 3, 4, 5, 6, 7, 8, 9, and 0. In the corresponding position in the keyboard according to the invention, the numeric characters are located on the left-side of the keyboard (shown in FIGS. 1 and 2 in the present application), so that an engineer is able to use numeric keys with his or her left hand and the mouse with his or her right hand, thus making use of the keyboard and mouse much easier.

The objectives are achieved by means of a keyboard as described above. Specifically the numeric digits are located on the opposite side of their location in a conventional keyboard to the left-side of the keyboard. Thus, the keyboard according the this invention provides an advantageous solution to the problem of switching the user's right hand between the numeric keys on the keyboard and the mouse. This increases the working speed and at the same time avoids shifting the use of the right hand, with its attendant distraction and confusion, between the keyboard and the mouse or avoids trying to use the keyboard and mouse by different hands so as to not stop to switch hands between the keyboard and the mouse.

### BRIEF DESCRIPTION OF THE DRAWINGS

FIG. 1 is a top plan view of a keyboard according to the present invention; and

FIG. 2 is a top plan view of the keyboard showing the elements of keyboard according to the invention.

### DETAILED DESCRIPTION OF THE EMBODIMENTS

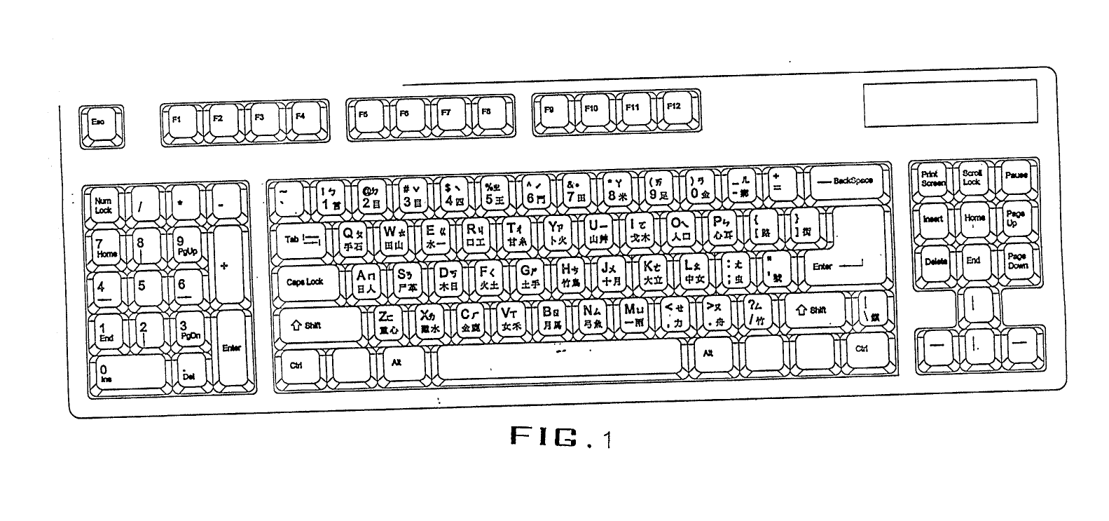

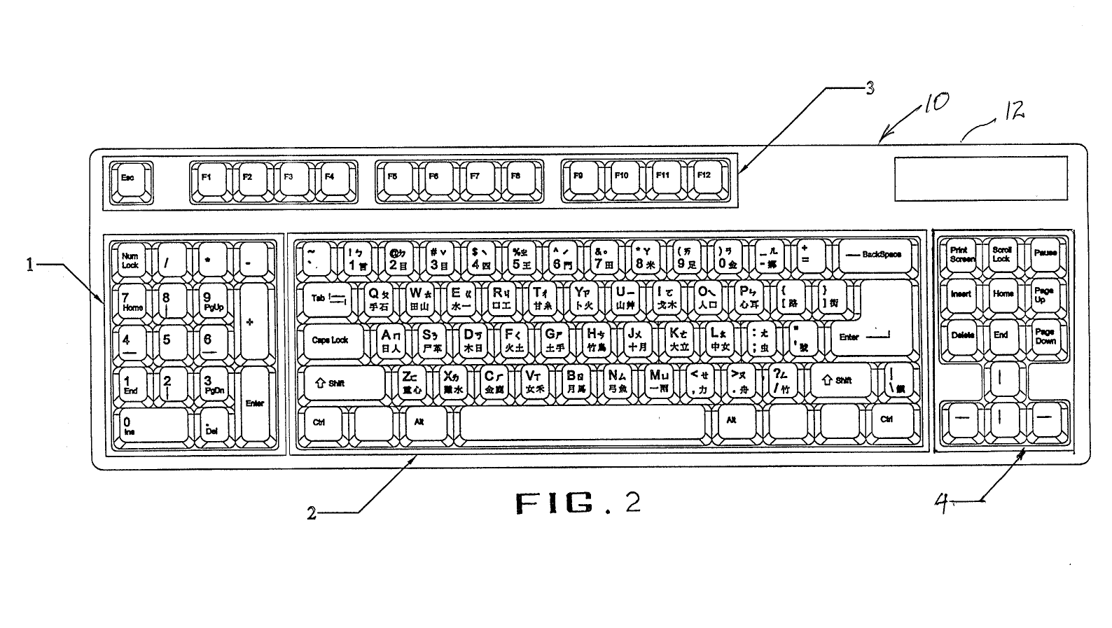

One specific embodiment of a keyboard 10 both for left and right hands or one-handed operation according to the invention is shown in the accompanying FIGS. 1 and 2. However, it is understood that modifications and variations are possible for a person skilled in the art without departing from the general idea of the invention.

Keyboard 10 has a rectangular housing or base 12 that contains the groups of keys. FIGS. 1 and 2 show the principal layout of keyboard 10 according to the invention. The layout is based on a conventional keyboard, but includes a numeric keypad 1 having a number of digit number keys located on the left side of keyboard housing 12. These digit keys are the conventional numbers 1, 2, 3, 4, 5, 6, 7, 8. 9, and 0, and are so designated in the figures. Keypad 1 also includes a number of arithmetic keys, namely a divide key (designated with a forward slant symbol), a multiply key (designated with an asterisk), a minus key (designated with a dash symbol), a plus key (designated with a plus sign), and a period key (designated with the symbol for a period). In addition, keypad 10 includes a number of conventional operation keys, namely an enter key and a numbers lock key (designated with the text “Num Lock”). Finally, keypad 10 includes a number of conventional dual function keys, namely the 7, 8, 9, 4, 6, 1, 2, 3, 0, and the period keys, which keys take on a second function when the numbers lock key is toggled. These extra, conventional functions are respectively: “Home;” Up cursor key (designated with the arrow symbol for the up cursor); “Page Up” key (designated with the text “PgUp”); Left cursor key (designated with the arrow symbol for the left cursor); Right cursor key (designated with the arrow symbol for the right cursor); “End;” Down cursor key (designated with the arrow symbol for the down cursor), “Page Down” key (designated with the text “PgDn”); Insert (designated with the text “Ins”), and Delete (designated with the text “Del”).

Keyboard 10 also has a group 2 of character keys located to the right of keypad 1 and in the central part of keyboard housing 12, a group 3 of function keys, located in this embodiment across the top of the keyboard housing 12, and a group 4 of control keys, located on the right side of keyboard housing 12. Group 2 character keys include the conventional English alphabet arranged in the conventional “QUERTY” key arrangement. The Group 2 keys also include the conventional symbol keys, namely the tilde/reverse apostrophe key, the underline/dash key, the plus/equal key, the left bracket key, the right bracket key, the colon/semicolon key, the asterisk/apostrophe key, the left caret/comma key, the right caret/period key, the question mark/forward slant key, and the vertical line/back slant key. Finally, group 2 character keys include a number of cursor positioning keys, namely: the backspace key, the enter key, two shift keys, two control keys (designated with the text “Ctrl”), two alternate keys (designated with the text “Alt”), a space bar key, a Caps Lock key, and a Tab key. A number of the Group 2 keys have superimposed thereon the conventional layout of Chinese character keys that are used with conventional Chinese word processors.

The Group 3 function keys include the conventional keys F1 to F12 and also include the escape key (designated with the text “Esc”). These keys have a different function depending upon the application program that is currently running.

The Group 4 control keys include the Print Screen key, the Scroll Lock key, and the Pause key. In addition, the Group 4 control keys duplicate the second of the dual functions of those previously described keys in keypad 1, namely: the Insert key, the Home key, the Page Up key, the Page Down key, the End key, and the Delete key, as well as the four cursor control keys.

This layout of the keyboard corresponds to a left-handed version for a right hand user who can thus work simultaneously with both the keyboard and the mouse.

As previously described the right-hand and left-hand of a user are able to work simultaneously, and a user not need switch his or her right hand between the keyboard and a mouse.

The various above embodiments of the invention, and specifically the said layout of keyboard are to be considered as specific example of embodiments of the invention. It will be possible for a person skilled in the art to devise other embodiments of the invention without departing from the general idea of the invention as set forth in the appended claims.

What is claimed is:

1. A keyboard that includes an arrangement of numerical digit keys forming a numeric keypad located at a left portion of the keyboard, and alphabetical keys located to the right of said numeric keypad.

2. The keyboard as claimed in claim 1, and further including a plurality of function keys located across a top portion of the keyboard.

3. The keyboard as claimed in claim 2, wherein said alphabetical keys are located in a central portion of the keyboard; and
including a plurality of control keys located in a right portion of the keyboard.

4. The keyboard as claimed in claim 1, wherein said alphabetical keys are located in a central portion of the keyboard; and
including a plurality of control keys located in a right portion of the keyboard.
